(19) United States
(12) Patent Application Publication
(10) Pub. No.: US 2024/0286094 A1
(43) Pub. Date: Aug. 29, 2024

(54) MIXING TANK ARRANGEMENT

(71) Applicant: KLEENER POWER SOLUTIONS OY, Vuolijoki (FI)

(72) Inventor: Pekka HILTUNEN, Vuolijoki (FI)

(21) Appl. No.: 18/571,516

(22) PCT Filed: Jun. 16, 2022
(86) PCT No.: PCT/EP2022/066442

§ 371 Date: Dec. 18, 2023

(30) Foreign Application Priority Data
Jun. 18, 2021 (EP) 21180342.4

(51) Int. Cl. B01F 25/50; B01F 23/50; B01F 25/21; B01F 35/11; B01F 35/53

(52) U.S. Cl. CPC B01F 25/50; B01F 23/51; B01F 25/21; B01F 35/11; B01F 35/53

(57) ABSTRACT

A mixing tank arrangement, comprising a tank (102) having at least one feed opening (104, 106) for feeding a first and a second material into the tank. The mixing tank arrangement further comprises a recirculation system having a first inlet (110) and a first outlet (112) for recirculating and mixing the first and the second material in the tank. The first inlet (110) comprises a body pipe (116) in a first side (FS) of the tank having a plurality of feeding pipes (118) extending to a second side (SS) of the lank wherein the feeding pipes are configured to jet the first and second materials from the second side to the first side of the tank such that the first and the second material hit a wall of the tank in the first side and wherein a shape of the wall is configured to divide the first and the second materials to at least two streams that flow to the second side of the tank and collide.

### TECHNICAL FIELD

The present invention relates to a field of mixing tank arrangements, especially the mixing tanks arrangements based on a jet mixing.

### TECHNICAL BACKGROUND

A jet based mixing tank arrangements are widely used in a process industry to combine two or more materials together inside the tank. There is a plurality of solutions available in a market for the mixing two or more materials together in the tank by the jetting. Still there are also many drawbacks in the known mixing tank solutions, especially from efficiency point of view that is very important in the process industry. Hence, there is a need for more sophisticated jet based mixing tank arrangement to mix two or material together in the tank.

### BRIEF DESCRIPTION

The present invention is defined by the subject matter of the independent claims.

Embodiments are defined in the dependent claims.

The embodiments and features, if any, described in this specification that do not fall under the scope of the independent claims are to be interpreted as examples useful for understanding various embodiments of the invention.

### BRIEF DESCRIPTION OF THE DRAWINGS

In the following the invention will be described in greater detail by means of preferred embodiments with reference to the attached drawings, in which

FIG. 1 illustrates a side view of a mixing tank arrangement according to an embodiment of the invention;

FIGS. 2 and 4 illustrate a cross section view of the mixing tank arrangement according to an embodiment of the invention;

FIG. 3 illustrates a top view of the mixing tank arrangement according to an embodiment of the invention; and

FIG. 5 illustrates a flow chart of a method of using the mixing tank arrangement according to an embodiment of the invention.

### DETAILED DESCRIPTION OF THE INVENTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

There is a plurality of different kind of the mixing tank solutions available for a process industry in the market. Yet there are many drawbacks in the known mixing tanks. One drawback is efficiency of the mixing and another one is cleaning of the tank. Cleaning of the tank refers the issue that occurs especially when combining liquid and solid material together. The solid material may accumulate and get lumpy that may cause obstructions and affect the mixing efficiency. Therefore, there is a need for the mixing tank arrangement that can provide the efficient mixing as well as a solution to avoid the accumulation related issues in the tank.

According to an aspect, there is provided a mixing tank arrangement, comprising: a tank having a curved wall and at least one feed opening for feeding at least a first and a second material into the tank, wherein the at least one feed opening is coupled with a feeding system for controlling feeding of the at least first and the second material into the tank, and a recirculation system having a first inlet and a first outlet for recirculating and mixing the first and the second material in the tank, wherein the first inlet comprises a body pipe in a first side of the tank having a plurality of feeding pipes extending to a second side of the tank which is substantially opposite side of the first side, wherein the feeding pipes are configured to jet at least the first and second materials from the second side to the first side of the tank such that the first and the second material hit a wall of the tank in the first side and wherein the curved shape of the wall is configured to divide the at least first and the second materials to at least two streams that follow the curved shape of the wall and flow to the second side of the tank and collide.

In an embodiment, the first material is solid. It may comprise ash, for example. In an embodiment, the second material is liquid. It may comprise water, for example. The mixing arrangement according to the invention may be used to mix more than two (first and second) materials together. The term “materials” used later in this application refers to all materials that are fed into the tank for mixing.

Referring to FIG. 1 that illustrates the mixing tank arrangement. FIG. 1 is a cross section of the tank from a longitudinal direction such that inner components and parts are visible. The mixing tank arrangement 100 comprises the cylindrical tank 102. The cylindrical tank comprises two end walls FE, SE and a curved surface CS between the ends. The curved surface refers to a curved (side) wall of the tank. In an embodiment, a cross section of the tank in a width direction is substantially circular. The width direction refers to a direction that is substantially perpendicular to the longitudinal axis. The cross section may also be oval.

In embodiment, the tank is a horizontal tank, in other words, tank is configured to be used in the horizontal (lateral) position to get desired material flows inside the tank. This is illustrated, for example, in FIG. 1.

In another embodiment, the tank is a vertical tank. Nevertheless, the example and embodiments in this application are presented mainly with the horizontal tank, the invention may still be applied also for the vertical tank.

The tank may have at least first feed opening 104 used for feeding at least the first and the second materials to mixed into the tank. The first feed openings is coupled with the feeding system for controlling feeding of the at least first and the second material into the tank via the first and the second feed openings. The feeding system as such may not be a part of the invention nevertheless it is used to control feeding of the material through the feed opening. The feeding system is neither illustrated in the drawings. The feeding system may comprise a controller coupled with a power source that creates a feeding pressure, for example, for feeding pipes coupled with the at least first feed opening. This kind of solutions are well known in the prior art and can be seen obvious to the skilled person and therefore not described with greater details in this application.

The mixing tank arrangement comprises the recirculation system 108 having the first inlet 110 and the first outlet 112 configured to recirculate the at least first and the second materials in the tank 102. The mixing of the at least first and second materials that are fed into the tank 102 is achieved by the recirculation. The materials to mixed are recirculated such that the materials are removed from the tank via the first outlet and supplied back to the tank via the first inlet. The recirculation system generates material streams inside the tank that causes mixing of the materials fed into the tank. The recirculation system may further comprise a power source 114, for example, a pump for providing driving force for the system. The power source is used for creating a desired pressure for the recirculation of the materials. The recirculation system may be coupled with a controller or may comprise the controller for controlling operations of the recirculation system.

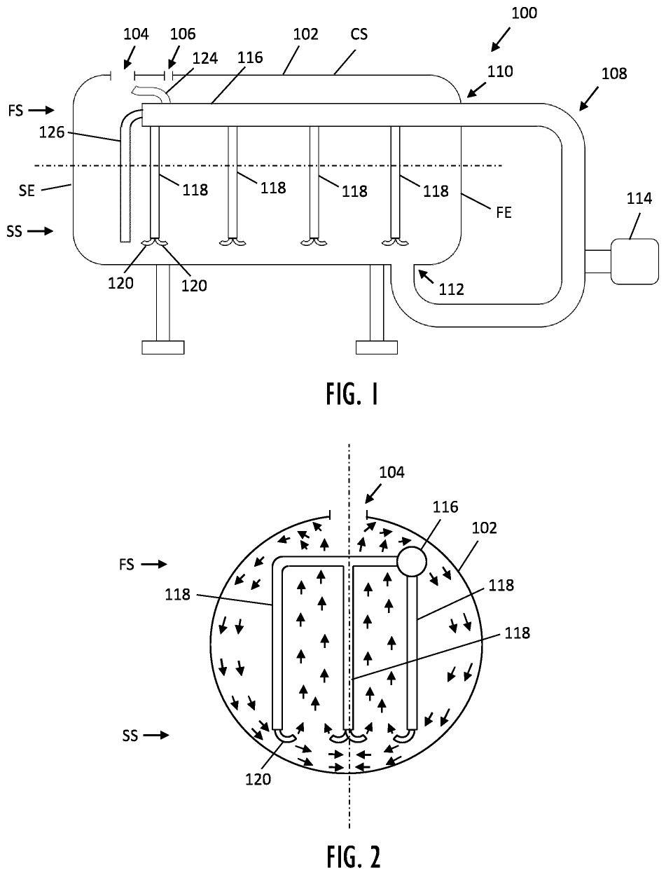

The first inlet 110 of the recirculation system 108 comprises the body pipe 116 having a plurality of the feeding pipes 118. The body pipe 116 is the main pipe used to supply the recirculated materials to the feeding pipes 116 that feed the material into the tank 102. The feeding pipes are branches of the body pipe and are open at the other ends. The recirculated materials are fed through the open ends into the tank. The body pipe 116 is in the first side FS of the tank 102. The first side may be the upper side (part) of the tank, if the tank is in the horizontal position as illustrated in FIG. 2. The body pipe may be in vicinity of the wall of the tank. In other words, the body pipe may be near by the wall in the first side of the tank. There may be a gap between the wall and the body pipe allowing the material flow between the body pipe and the wall. The feeding pipes 118 extend from the body pipe 116 to the second side SS of the tank 102 and the ends of the feeding pipes may be in vicinity of the wall of the tank in the second side. In other words, the feeding pipes may extend in the vicinity of the wall in the second side of the tank such that there is a gap between the wall and the end of the body pipe allowing the material flow between the feeding pipe and the wall. The second side may be the lower side (part) of the tank, if the tank is in the horizontal position as illustrated in FIG. 2. A diameter of the body pipe is larger than the diameter of the feeding pipe(s) to get proper pressure. The diameter of the individual feeding pipe(s) may vary in the recirculating system, in other words, the diameter of all feeding pipes is not necessarily the same.

The feeding pressure may be adjusted according to the needs. The pressure is at least configured to enable jetting of the materials from the second side to the first side of the tank such that the materials hit the wall properly and causes the mixing of the materials, and further causes streams back to the second side of the tank. The first and the second sides may be opposite sides of the tank.

In an embodiment, the pressure inside the body and/or feeding pipes presses the second material, that may be liquid like water, into the first material, that may be solid like ash, in the recirculation process. This causes an effect wherein the combination of the solid and liquid disintegrates when fed out of the pipes where the pressure is smaller than in the pipes.

In an embodiment, the second side of the tank is opposite to the first side of the tank.

The body pipe extends from the first end FE of the tank 12 towards the second end SE of the tank 102. Hence, the body pipe may extend in the longitudinal direction of the tank. The first inlet may locate at the first end of the tank. The body pipe is coupled with the inlet and may then also be coupled with the first end of the tank. The body pipe is not necessarily in contact with the second end. As mentioned, the body pipe is in the first side of the tank and the feeding pipes may extend from the body pipe towards the second side of the tank. The body pipe and/or the feeding pipes may further comprise fastening elements used to fasten the pipes into the tank.

There may be a plurality of feeding pipes in the body pipe consecutively in the longitudinal direction of the tank. FIG. 1 illustrates the four consecutive feeding pipes 118 in the longitudinal direction of the tank 102. In addition, there may be a plurality of the feeding pipes side by side in the width direction of the tank. FIG. 2 illustrates the three adjacent feeding pipes 118 in the width direction of the tank 102. Amount of the feeding pipes may vary according to the needs.

The mixing tank arrangement is configured to provide rotating and colliding flows of the materials inside tank. This movement causes an abrasive affect for the material and abrades particles of the materials smaller. This also rises a temperature of the materials. This movement enables very efficient mixing of the materials, it may also generate a chemical reaction in the tank.

Referring to FIG. 2 which is a simplified cross section from the width direction of the tank. FIG. 2 illustrates the body pipe 116 in the first side FS of the tank 102 having three feeding pipes 118 arranged side by side in the width direction of the tank. As described above, there may be several feeding pipes consecutively in the longitudinal direction of the tank, but these are not visible in FIG. 2. The feeding pipes 118 extend from the body pipe 116 towards the second portion of the tank. The feeding pipes 118 jet the materials from the second side SS of the tank 102 to the first side FS such that the materials hit the wall in the first side of the tank FS. So, the feeding pipes are configured to jet the material to opposite side of the tank. The materials start to mix when they hit and/or collide with the wall in the first side of the tank. Arrows illustrates the flow of the materials inside the tank. When the materials are jet against the wall in the first side of the tank, the wall also splits the materials into at least two different streams that follow the shape of the wall and flow back to the second side of the tank. As described above, the wall of the tank may be the curved surface and the two streams follow the curved shape of the wall back to the second side. The curved wall also splits the jetted materials into two different streams as illustrated in FIG. 2. The curved wall refers to the side wall of the tank having substantially the cylindrical shape. In the second side of the tank the streams collide which generates the abrasive effect for the particles of the materials and rises the temperature of the materials. This enables effective mixing of the materials. There are two main steps in which the above mentioned effects take place. The first step is when the materials collide with the wall in the first side of the tank and the second step is when, after colliding with the wall, the material streams flow back to the second side of the tank and collide. The cylindrical shape of the tank enables above mentioned effect. As illustrated in FIG. 2, the cross section of the tank is substantially round. The body pipe may be arranged in the upper side of the tank and the feeding pipes extend from the upper side to lower side of the tank. The feeding pipes are arranged such that they are capable of jetting materials from the lower side to upper side of the tank. The materials hit the curved wall on the upper (top) side of the tank and the curved shape of the wall divides the materials into two streams as illustrated in FIG. 2. The two material streams follow the curved outer wall back to the lower side where they collide.

In an embodiment, the mixing tank arrangement comprises at least the first feed opening 104 for feeding the first material into the tank 102 and a second feed opening 106 for feeding the second material into the tank 102. The first feed opening may be used for feeding the solid material like ash into the tank, for example. The second feed opening may be used for feeding the liquid like water into the tank, for example.

Referring to FIGS. 1 and 2, in an embodiment, the feeding pipes 118 comprises nozzles 120 to get the desired jet of the materials inside the tank. The nozzles 120 may be at the open ends of the feeding pipes that are in the second side SS of the tank 102. The nozzles may extend to the width and/or longitudinal direction of the tank. In FIG. 1 the nozzles extend in the longitudinal direction and in FIG. 2 in the width direction of the tank. The nozzles may be removable coupled with the feeding pipes and can be changed. Type of the nozzles may be selected according to the desired jet. The type of the nozzles may affect the feeding pressure, for example.

In an embodiment, the first side FS of the tank 12 refers to an upper portion of the tank when the tank is in the horizontal position as illustrated for example in FIGS. 1 and 2. In other words, the upper side is the portion of the tank which is substantially above a centre line of the tank in the longitudinal direction, the centre line is illustrated in FIG. 1 as a dash line.

In an embodiment, the second side SS of the tank 102 refers to a lower portion of the tank when the tank is in the horizontal position as illustrated for example in FIGS. 1 and 2. In other words, the lower side is the portion of the tank which is substantially under the centre line of the tank.

In an embodiment, the first feed opening 104 is on the top of the tank 102. The first feed opening 104 may be in the curved surface CF or in the end wall FE, SE. Preferably the first feed opening is on the top of the curved surface of the tank like illustrated, for example, in FIG. 1. The top of the tank refers the portion of the tank which is substantially above the centre line of the tank. The location of the first feed opening may be such that it is above a material line inside the tank. The material line refers to a surface level of the materials in the tank when the tank is filled properly. For example, two thirds of the tank may be filled with the materials and then one third is empty from the materials. The one third is obviously the upper most part of the tank and this may the portion of the tank wherein the feed opening(s) is/are placed. This has many advantages, for example, when feeding solid material into the tank the solid material does not accumulate at the opening when contacting with liquid.

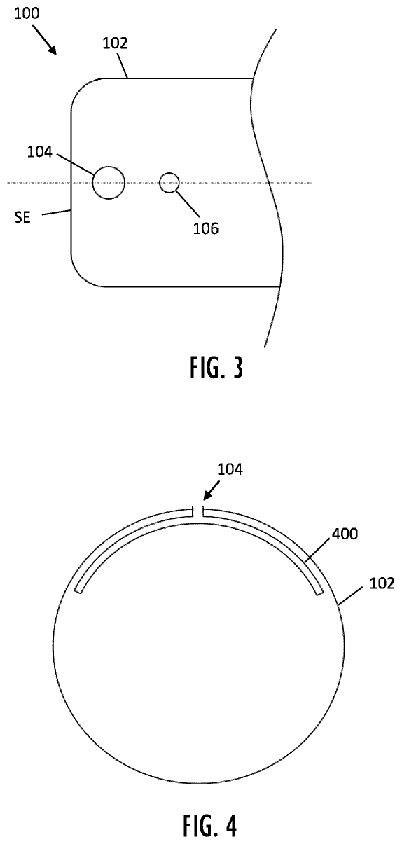

In an embodiment, the first feed opening is on the top of the tank in vicinity of a centre line of the container. In other words, the first feed opening is substantially in the middle of the of the tank in the width direction. Referring to FIG. 3 in which the second end SE with a part of the curved surface CS of the tank 102 is illustrated from the top view and the first opening 104 is in placed vicinity of the centre line (dash line). In the embodiment of FIG. 3, the first feed opening 104 is substantially in middle of the centre line of the tank 102. This is the most optimal location from material feeding point of view. A distance from the first feed opening is long to the bottom of the tank and hence, most of the material fed into the tank via opening has time to mix with other material(s) when recirculated by the recirculation system.

In an embodiment, the first feed opening is on the top of the curved surface CS and in vicinity of the second end SE of the tank.

Referring to FIG. 2, in an embodiment, the body pipe 116 is out of the centre line of the tank. In other words, the body pipe 116 is not in the same line with the first feed opening 104 when viewing the tank for example from the second end. Then the material fed through the first feed opening does not hit the relatively wide body pipe and the material can flow towards the bottom of the tank without obstacles. In an embodiment, all other pipes inside the tank are arranged such that they will not block the material flow through the first feed opening towards the bottom of the tank. In other words, there may not be pipes or other blocking elements in a feeding line of the material of the first feed opening.

In an embodiment, the second feed opening is on the top of the tank. The second feed opening may be in the curved surface or in the end wall. Preferably the second feed opening is in the top of the curved surface of the tank as illustrated for example in FIG. 1. In an embodiment, the second feed opening is on the top of the tank and in vicinity of the centre line of the tank like the first feed opening. This is illustrated in FIG. 3.

In an embodiment, the second feed opening comprises at least one spraying pipe configured to feed the second material into the tank. FIG. 4 illustrates a simplified cross section view of the tank from the end direction such that the spraying pipe is visible. Referring to FIG. 4, the spraying pipe 400 extends inside the tank and has hole(s) for spraying the material. The spraying pipe 400 may comprise spraying holes in both ends of the pipe. The spraying pipe 400 may extend in the width direction inside the tank 102.

Still referring to FIG. 4, in an embodiment, a shape of the spraying pipe 400 of the second feed opening 104 is half-arch. The spraying pipe may be coupled with the second feed opening substantially from the middle of the pipe. Then the spraying pipe may extend substantially equally to the both direction from the second feed opening. The shape of the pipe may follow substantially the round shape of the tank so the pipe extends along the curved surface of the tank. The ends of the spraying pipe may extend to the middle of the tank.

In an embodiment, the spraying pipe of the second feed opening comprises a plurality of holes for feeding the material. In addition to the holes in the ends of the spraying pipe, the pipe may comprise one or more spraying holes in a body of the pipe. The body is a curved surface between the ends of the pipe.

In an embodiment, the spraying pipe is used to oxidate the content of the tank.

In an embodiment, the mixing tank arrangement further comprises a first cleaning pipe extending from the body pipe configured to jet materials towards the first feed opening. Referring to FIG. 1, the body pipe 116 may further comprise the first cleaning pipe 124 configured to jet the materials towards the first feed opening 104. The jetted materials clean the feed opening and hence, prevents blocking of the opening by the material fed into the tank via opening. For example, if the first material fed through the first opening is ash and the second material is liquid, the ash may easily accumulate when it is in contact with liquid. The accumulation of ash may then block at least partly the material flow through the first feed opening which may disturb the whole mixing process. The first cleaning pipe cleans the first feed opening when the materials are recirculated by the recirculation system and hence, enables fluent flow of the material into the tank.

In an embodiment, the first cleaning pipe comprises an actuator for controlling jetting of the material. The actuator is configured to open and close the first cleaning pipe such that the jetting of the materials is enable only when needed. The cleaning is not necessarily needed all the time when recirculating and mixing the materials. When the cleaning of the first feed opening is needed, the actuator opens the first cleaning pipe such that it jets materials towards the opening. Respectively when the first feed opening is clean, the actuator closes the first cleaning pipe and jetting of the materials stop. With the actuator, use of the first cleaning pipe can be controlled and used only when needed.

Still referring to FIG. 1, in an embodiment, the mixing tank arrangement 100 further comprises a second cleaning pipe 126 extending from the body pipe 116 towards the second side SS of the tank wherein the second cleaning pipe 126 is configured to jet materials towards an area of the tank 102 to which the first material is fed from the first feed opening 104. If the material fed into the tank from the first feed opening is solid, it may accumulate inside the tank in some point or area.

In an embodiment, the second cleaning pipe comprises the actuator for controlling jetting of the material. The structure and function of the actuator used with the second cleaning pipe may be same as used with the first cleaning pipe described above.

In an embodiment, the area of the tank to which the first material is fed through the first feed opening is substantially on the opposite side of the first feed opening inside the tank. For example, if the first feed opening is on the top of the tank as described earlier, the material fed into tank through the opening may accumulate on the bottom of the tank in the area which is opposite to the opening. The second cleaning pipe 126 is configured to jet the recirculated materials to this area to prevent accumulation of the materials inside the tank. Hence, the second cleaning pipe keeps the tank clean inside. If the material accumulates it may affect the mixing efficiency of the tank and can also block the pipes of the recirculation system.

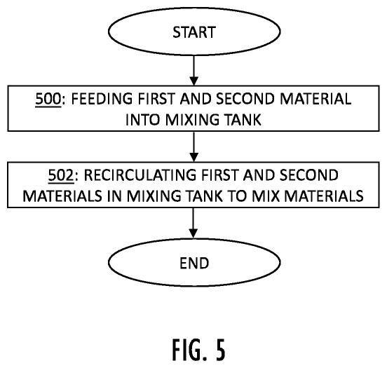

Referring to FIG. 5 which is a flow chart of a method for mixing the materials in the mixing tank arrangement according to an embodiment. The method comprises following steps:

feeding [step 500], by a feeding system, at least a first and a second material through at least one feed opening into the mixing tank; and
recirculating [step 502], by the recirculation system, at least the first and the second material in the tank mixing tank to mix at least the first and the second materials,
wherein the recirculation system comprises a first inlet comprising a body pipe in a first side of the tank having a plurality of feeding pipes extending to a second side of the tank which is substantially opposite side of the first side, and wherein the feeding pipes are configured to jet at least the first and second materials from the second side to the first side of the tank such that the first and the second material hit a wall of the tank in the first side and wherein a curved shape of the wall is configured to divide the at least first and the second materials to at least two streams that follow the curved shape of the wall and flow to the second side of the tank and collide.

In another embodiment the method for mixing materials with the mixing tank arrangement comprises following step: feeding, by a feeding system, a first predetermined amount of a second material through a second feed opening into the mixing tank; feeding, by the feeding system, a first predetermined amount of a first material through a first feed opening into the mixing tank; starting, by a recirculation system, a recirculation of the first and the second materials in the tank; feeding, by the feeding system, more the first and the second materials through the first and the second feed openings into the mixing tank at the same time during the recirculation; stopping, by the feeding system, feeding of the first material into the mixing tank; and feeding, by the feeding system, a predetermined time the second material through the second opening into the mixing tank after stopping feeding of the first material.

In the first step of the mixing process the predetermined amount of the second material is fed into the tank through the second feed opening. The second material may be water. After adding water into the tank, the predetermined amount of the first material is fed into the tank through the first feed opening. The first material may be ash. After adding the materials into the tank, recirculation system starts to recirculate materials in the mixing tank. The recirculation and mixing may be on already when feeding the predetermined amount of the first and/or second materials into the tank. The feeding of the water and ash is continued at the same time during the recirculation and mixing. When desired amount of ash is in the tank, feeding of the ash is stopped by the feeding system. The feeding of water is continued for the predetermined time after stopping the feeding of the ash. The recirculation and mixing are continued until desired composition of ash and water is achieved.

Next example describes how the invention may be used for mixing two or more materials. The first feed opening is used to feed the first material into the tank. The first material may be solid like ash, for example. The second feed opening is used to feed the second material into the tank. The second material may be liquid like water, for example. Feeding of the first and the second materials is controlled by the feeding system. The circulation system of the mixing tank comprises the at least one inlet, at least one outlet and a power source like the pump for generating the circulation of the materials. The feeding system may first feed the first predetermined amount of water into the tank and then the first predetermined amount of ash. It is important to feed water into the tank prior to ash. The recirculation system starts to recirculate the added ash and water. During the recirculation, more water and ash are fed into the tank until desired mount of ash and water is in the mixing tank. Then the feeding system stops feeding of the ash and continues feeding of the water a predetermined time. Then desired composition of ash and water is in the tank. The recirculation process may be continued after stopping the feeding of the materials.

Ash and water that are fed into the tank are recirculated such that the pump sucks ash and water via the outlet and feed them back to the tank via the inlet. The inlet comprises the body pipe having a plurality of feeding pipes with nozzles. The arrangement and of the feeding pipes and the shape of the tank generates rotational movement of the material streams consisting of ash and water such that the material streams collide inside the tank. The collision causes mixing of ash and water. In addition, the collision causes the abrasion of the particles of the materials and further generates the chemical reaction. The abrasion of the particles caused by the collision causes also rising of the temperature of the materials. In addition, the cleaning pipes of the arrangement prevent accumulation of the materials inside the tank and hence, the mixing process is very efficient without unnecessary stops.

Even though the invention has been described with reference to one or more example embodiments according to the accompanying drawings, it is clear that the invention is not restricted thereto but can be modified in several ways within the scope of the appended claims. All words and expressions should be interpreted broadly, and they are intended to illustrate, not to restrict, the example embodiments. It will be obvious to a person skilled in the art that, as technology advances, the inventive concept can be implemented in various ways.

1.-15. (canceled)

16. A mixing tank arrangement, comprising:
a horizontal tank having a first end, a second end and a curved side wall between the ends, the tank comprises at least one feed opening for feeding at least a first and a second material into the tank, wherein the at least one feed opening is coupled with a feeding system for controlling feeding of the at least first and the second material into the tank; and
a recirculation system having a first inlet and a first outlet for recirculating and mixing the first and the second material in the tank,
wherein the first inlet comprises a body pipe in an upper side of the tank, extending in a longitudinal direction of the tank, having a plurality of feeding pipes, extending to a lower side of the tank, configured to jet the at least first and the second material to the upper side of the tank,
wherein the recirculation system is configured to provide a pressure for jetting the at least first and second material through the feeding pipes from the lower side to the upper side of the tank such that the first and the second material hit the curved side wall of the tank in the upper side, and wherein the curved shape of the side wall in the upper side is configured to divide the at least first and the second materials to at least two streams that flow on the opposite sides of the tank following the curved shape of the side wall to the lower side of the tank and collide in the lower side of the tank.

17. The mixing tank arrangement of claim 16, wherein the arrangement comprises at least a first feed opening for feeding the first material into the tank and a second feed opening for feeding the second material into the tank.

18. The mixing tank arrangement of claim 16, wherein ends of the feeding pipes extending to the lower side of the tank comprise removable nozzles configured to provide the desired material jet.

19. The mixing tank arrangement of claim 17, wherein the first feed opening is on the top of the tank.

20. The mixing tank arrangement of claim 17, wherein the first feed opening is substantially in a centre line of the tank.

21. The mixing tank arrangement of claim 16, wherein the body pipe is out of the centre line of the tank.

22. The mixing tank arrangement of claim 17, wherein the second feed opening is on the top of the tank.

23. The mixing tank arrangement of claim 17, wherein the second feed opening comprises at least one spraying pipe configured to spray the second material into the tank.

24. The mixing tank arrangement of claim 16, wherein the arrangement further comprises a first cleaning pipe extending from the body pipe configured to jet materials toward the first feed opening.

25. The mixing tank arrangement of claim 24, wherein the first cleaning pipe comprises an actuator for controlling jetting of the material.

26. The mixing tank arrangement of claim 24, wherein the arrangement further comprises a second cleaning pipe extending from the body pipe configured to jet materials towards an area of the tank to which the first material is fed via the first feed opening.

27. The mixing tank arrangement of claim 26, wherein the area of the tank to which the first feed opening feeds the first material is substantially on the opposite side of the first feed opening inside the tank.

28. A method for mixing materials in a mixing tank arrangement, comprising:
feeding, by a feeding system, at least a first and a second material through at least one feed opening into a horizontal tank; and
recirculating, by the recirculation system, at least the first and the second material in the tank to mix at least the first and the second materials,
wherein the recirculation system comprises a first inlet comprising a body pipe in an upper side of the tank, extending between a first and a second end of the tank, having a plurality of feeding pipes, extending to a lower side of the tank, configured to jet the at least first and the second material to the upper side of the tank, and
wherein the recirculation system is configured to provide a pressure for jetting the at least first and second material through the feeding pipes from the lower side to the upper side of the tank such that the first and the second material hit a curved side wall of the tank in the upper side, and wherein the curved shape of the wall in the upper side is configured to divide the at least first and the second materials to at least two streams that flow on the opposite sides of the tank following the curved shape of the side wall to the lower side of the tank and collide in the lower side of the tank.
